(19) United States
(12) Patent Application Publication
(10) Pub. No.: US 2016/0128421 A1
(43) Pub. Date: May 12, 2016

(54) SPORT SHOE INNERBOOT

(71) Applicant: ROSSIGNOL LANGE S.R.L., Montebelluna (IT)

(72) Inventors: Ruggero Canova, Feltre (BL) (IT); Adriana Basso, Montebelluna (TV) (IT); Giovanni Meneghini, Cassola (VI) (IT)

(73) Assignee: ROSSIGNOL LANGE S.R.L., Montebelluna (IT)

(21) Appl. No.: 14/937,452

(22) Filed: Nov. 10, 2015

(30) Foreign Application Priority Data
Nov. 11, 2014 (EP) 14425143.6

(51) Int. Cl. A43B 5/04; B29D 35/12

(52) U.S. Cl. CPC A43B 5/0405; A43B 5/0486; B29D 35/126

(57) ABSTRACT

Sport shoe innerboot (1), including a wall including at least one layer that features an area formed of a thermoformable padding material (10) adapted to be shaped after heating it when it has been heated to a deformation temperature, characterized in that it includes at least one indicator (20), including a deformable element deforming at the deformation temperature of the thermoformable padding material (10) of the wall of the innerboot to indicate that the innerboot has been heated to a temperature substantially equal to its deformation temperature, at which shaping it is possible.

The present invention concerns a sport shoe innerboot as well as a sport shoe as such incorporating such a innerboot. It is particularly suitable for a ski boot innerboot, or more generally innerboot for board sports.

The document FR2460118 describes a ski boot innerboot the wall of which includes an inside layer filled with an expanded polyethylene element subjected to a thermo-compression process. This innerboot is then heated to a certain temperature at which the polyethylene foam tends to re-expand, to return to a part of the larger volume that it initially occupied before its thermo-compression. A person acquiring such a innerboot exploits this property to shape the innerboot to the shape of their foot: when the innerboot has been heated to the temperature of expansion of its wall, they put on the innerboot, the wall of which naturally comes to espouse the shape of their foot when it expands, then returning to this shape after it cools. This method enables everyone to customize the shape of the innerboot to the anatomy of their foot and to achieve optimum comfort.

In practice, this shaping of the innerboot is carried out at the point of sale of the innerboot, by the vendor. The latter first places the innerboot in an oven provided for this purpose and then takes it out when they estimate that its temperature is correct. In numerous cases it is found that the vendor does not leave the innerboot in the oven for long enough, notably if very busy and in a hurry, and the temperature reached by the innerboot is insufficient for its wall to be deformed, which renders the process ineffective. Alternatively, the vendor may by mistake also heat the innerboot to too high a temperature, in which case the purchaser may be inconvenienced by the heat. Moreover, at too high a temperature, the material could suffer irreversible damage. For these reasons, the shaping of existing innerboots at present proves to be somewhat unreliable.

An object of the invention therefore consists in proposing a sport shoe innerboot that can be shaped to the foot of a user reliably and safely.

To this end, the invention consists in a sport shoe innerboot indicator characterized in that it includes a deformable element adapted to be deformed at a deformation temperature of a thermoformable padding material of a wall of the innerboot to indicate that the innerboot has been heated to a temperature substantially equal to its deformation temperature.

The invention is more precisely defined by the claims.

These objects, features and advantages of the present invention will be explained in detail in the following description of particular embodiments given by way of nonlimiting example and with reference to the appended figures, in which:

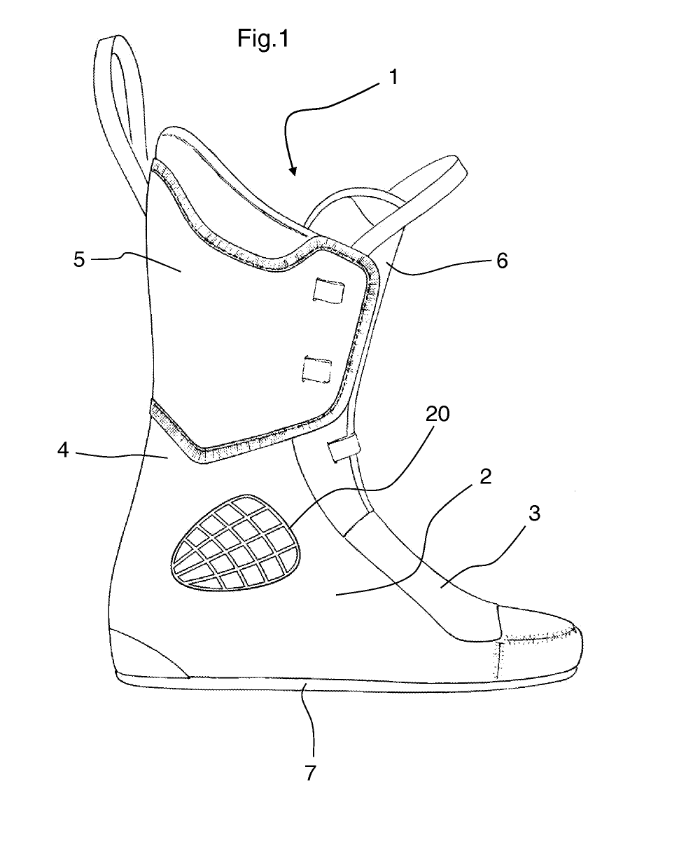

FIG. 1 represents a side view of a ski boot innerboot in accordance with one embodiment of the invention.

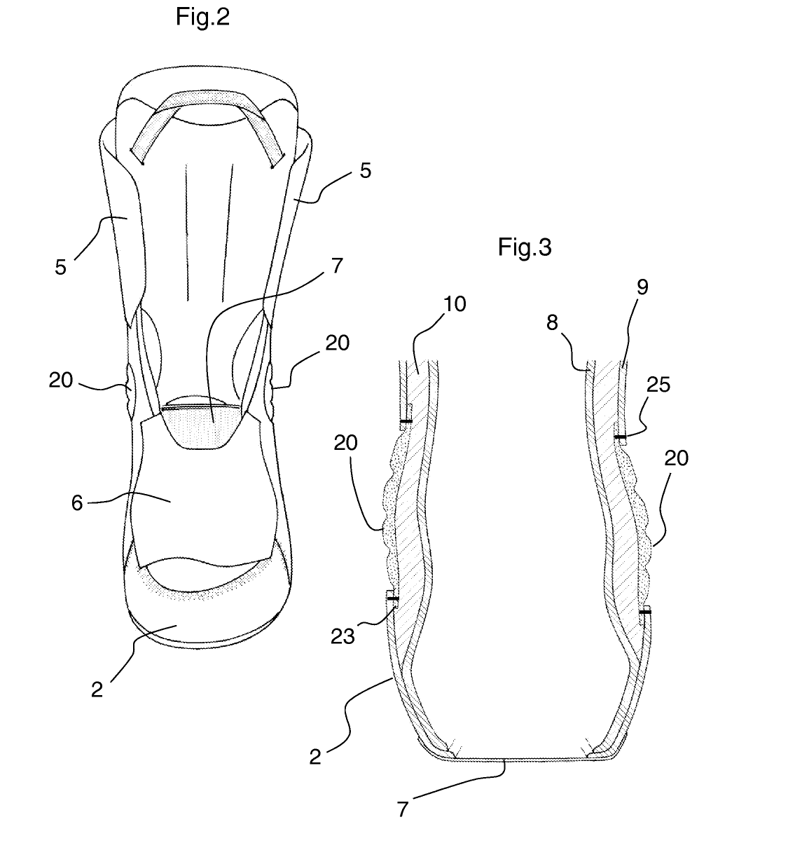

FIG. 2 represents a front view of the innerboot in accordance with the aforementioned embodiment of the invention.

FIG. 3 represents a sectional view of the innerboot in accordance with the aforementioned embodiment of the invention in a transverse vertical plane.

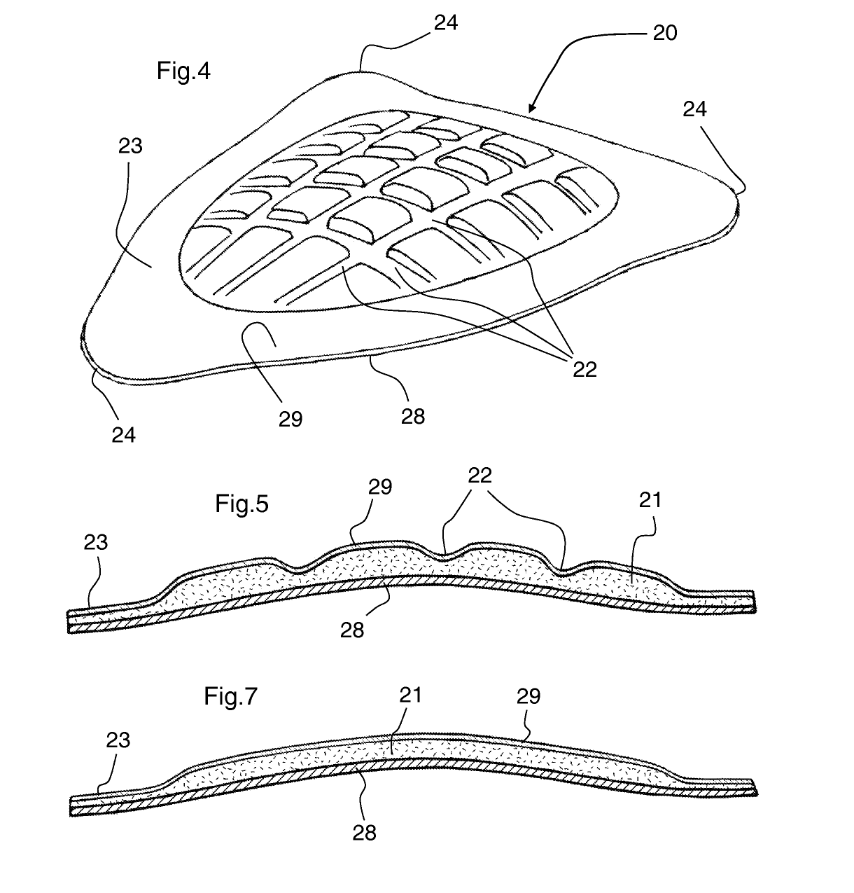

FIG. 4 represents a perspective view from above of an insert of the innerboot in accordance with the aforementioned embodiment of the invention.

FIG. 5 represents a sectional view of the wall of the insert of the innerboot in accordance with the aforementioned embodiment of the invention.

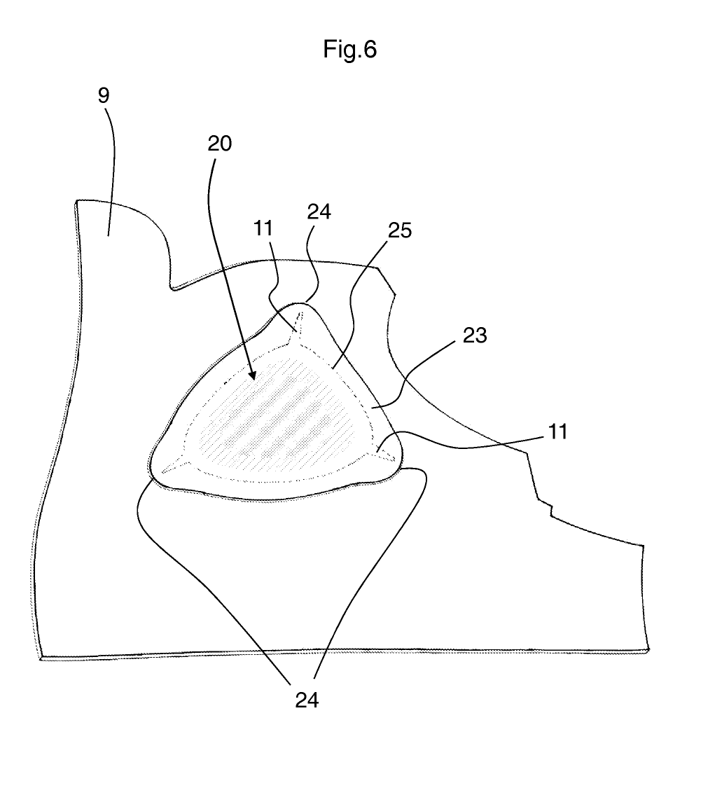

FIG. 6 represents a view of the inside wall at the level of the insert of the innerboot in accordance with the aforementioned embodiment of the invention.

FIG. 7 represents a sectional view of the wall of the insert in accordance with the aforementioned embodiment of the invention after deformation of the insert.

The invention is illustrated by means of a ski boot innerboot, in particular for alpine or Nordic skiing, but also for surfing and cross-country skiing, but it could also be implemented for any sport shoe innerboot, notably intended for board sports on snow or on water, and more generally for any sport shoe innerboot element, or even a sport shoe as such.

FIGS. 1 and 2 show an alpine ski boot comfort innerboot 1. This innerboot 1 has a conventional shape: it includes a bottom part 2 completely surrounding the foot, notably covering the instep 3 and rising to the level of the ankle 4, followed by a more open top part 5, intended to surround the lower leg, including two lateral flaps positioned at the front in the vicinity of a front tongue 6 fixed to the bottom part 2 at the level of the instep.

The top part is generally stiffer than the bottom part, but could also be of equivalent or lower stiffness. The top and bottom parts may be separate or possibly in one piece.

FIG. 3 shows the composition of the wall of the bottom part 2 of the innerboot, which includes three layers: an inside layer forming an inside lining 8, intended to be in contact with the foot, and an outside layer 9, intended to impart strength to the innerboot, delimiting an inside volume in which a thermoformable padding material 10 in the form of foam is positioned. This thermoformable padding material 10 is positioned on the inside wall of the outside layer 9 and is generally glued to the latter, and finally forms an intermediate padding layer of the wall of the innerboot. The thermoformable material generally used is a thermoplastic foam based on EVA and/or polyethylene. For example, this material may be Flexalon 45 with a density between 42 and 48 kg/m3.

When the innerboot has been heated to its deformation temperature and once the foot has been inserted in it, the thermoformable padding material 10 assumes the shape of the foot of the user in a stable and durable manner, notably by being compressed in the prominent areas of the foot. The inside lining 8 composed of a textile material tensioned over the padding material is preferably sufficiently flexible and/or elastic to guarantee the comfort of the foot and to accompany the deformation of the thermoformable foam material 10. This inside lining may be formed of a single layer or possibly of a plurality of layers or a plurality of materials. The outside layer 9 guarantees the stiffness and the strength of the innerboot. All these layers forming the wall of the innerboot are advantageously composed of textile or plastics materials with different stiffnesses and/or densities and are fastened together by glued and/or stitched or welded areas. Alternatively, the innerboot may have any other prior art architecture integrating a thermoformable material that is deformed in expansion and/or in compression after it is heated.

The intermediate padding layer is intended to enhance the comfort of the skier at the same time as gripping the foot to ensure efficient and sensitive control as well as precise transmission of mechanical forces to the skis via the boots. The padding material may extend over the bottom part and/or the top part of the innerboot and may be composed entirely of thermoformable materials or may be composed locally of non-thermoformable areas then consisting of appropriate materials such as EPDM foams.

The innerboot 1 further includes two indicators 20 each including a deformable material. In this embodiment, the indicators 20 take the form of an insert integrated into the outside layer 9 and disposed on each lateral flank of the bottom part 2 of the innerboot, approximately at the level of the malleolus.

FIGS. 4 to 6 show an indicator 20 adapted to be integrated into the innerboot 1 in accordance with this embodiment of the invention. As can be seen in the FIG. 5 cross-section, the indicator has a thickness between 4 and 6 mm, preferably between 5 and 5.5 mm, and is in particular thinner than the total thickness of the wall of the innerboot.

The indicator includes three layers fastened, preferably glued, together: a bottom layer 28 of thermoformable or non-thermoformable material such as polyurethane, for example, oriented toward the inside of the innerboot 1 in this embodiment and that imparts its structure to the insert, notably its shape and its stiffness, a top layer 29, oriented toward the outside of the innerboot 1, these two layers 28, 29 delimiting a central volume in which an intermediate layer of deformable material is disposed. In accordance with this embodiment, the deformable material 21 is a thermoformable material different from the thermoformable material used to form the padding 10 or may be identical or similar to the thermoformable material 10 in the intermediate padding layer of the innerboot. Before shaping it in the mould during its manufacture, the deformable material 21 of the insert is of constant thickness and extends over all of the surface of the insert. The thermoforming temperature of the bottom layer 28 could then be higher than the thermoforming temperature of the deformable material 21 of the insert to prevent modification of its shape by thermoforming in an oven in a store, this bottom layer 28 imparting the structure to the indicator.

In accordance with this embodiment, in a first step before mounting it on the innerboot, the indicator 20 has been heated and preformed in a mould to impart to it an appearance particularly visible to the naked eye, formed by a shape including raised and/or recessed portions on one of its faces in this embodiment. In the example shown, it has an upper surface forming a grid, produced by lines 22 of compression of the deformable material 21. Accordingly, the elastic top layer 29 features exactly the same grid as the deformable material layer 21 preformed beforehand. Naturally, any other pattern could be formed instead, preferably with sufficient compression lines and a distribution on the central surface of the indicator. The top layer 29 of the indicator, fastened, for example glued, to the deformable material layer 21 and visible from outside the innerboot has a flexible and/or elastic property to espouse the shape of the deformable material 21, thereby guaranteeing the outside visual effect. During this first thermoforming step, a peripheral area 23 around the thinner central surface is formed. This peripheral area 23 forms a surface for fixing the insert to the outside layer 9 of the innerboot. On its other face opposite the visible face, the indicator may also assume a specific shape, for example preshaped for enhanced comfort at the level of the malleolus, if the material of the bottom layer 28 is also thermoformable.

Different ways of manufacturing the insert in accordance with the invention are envisaged. In a first embodiment the insert is cut out from a sandwich sheet made up of three layers. In a second embodiment, the bottom layer 28 may be injection moulded on top of the other layers 21, 29 of the insert, the material used for the bottom layer 28 preferably being a polyurethane foam. In a third embodiment, the bottom layer 28 may be glued to a sandwich previously produced comprising the layers 21 and 29.

FIG. 6 shows the fixing of the insert 20 to the innerboot 1, the result of which can also be seen in FIG. 3, in an intermediate phase of a method of manufacturing said innerboot 1. It more particularly shows the inside face of the outside layer 9 of the innerboot before shaping the innerboot and therefore when it has a substantially plane shape. This outside layer 9 includes an opening at the level of the malleolus in which the insert 20 is housed with its top layer 29 oriented toward the outside of the innerboot. The peripheral area 23 of the insert 20 comes to bear on the inside face of the outside layer 9, around the abovementioned opening, and this peripheral area 23 is fixed to this outside layer 9 by stitches 25, preferably carried out over all the perimeter of the insert 20 to provide water-tightness. Alternatively, any other fixing means may be employed instead of or in addition to stitching, such as gluing or welding.

Note that, in this embodiment, the bottom layer 28 of the insert has a stiffness similar to that of the outside layer 9 of the innerboot 1. The insert therefore replaces a truncated surface of the outside layer and also has the function of ensuring continuity of the stiffness of the wall of the innerboot. Moreover, this geometry makes it possible to provide water-tightness at the level of the connection between the insert and the innerboot wall. To this end, the material of the bottom layer 28 of the insert, or even of the top layer 29, is inherently watertight and the fixing implemented at its perimeter also guarantees its water-tightness. In all cases, the water-tightness of the inside of the innerboot is guaranteed.

By way of one nonlimiting embodiment, the stiffer bottom layer 28 is preferably 2.5 mm thick and may consist of polyolefin with a weight per unit area between 70 and 300 kg/m2 inclusive, preferably 150 kg/m2, for example including polyethylene and optionally EVA (ethylene vinyl acetate). The top layer 29 has a thickness between 0.1 and 1 mm, preferably 0.5 mm, and may consist of a bi-elastic fabric such as Lycra, for example. The deformable material contained between these two layers 28, 29 preferably has a thickness of 2.5 mm, and may consist of polyolefin with a weight per unit area less than or equal to 100 kg/m2, preferably 30 kg/m2, for example including polyethylene and EVA (ethylene vinyl acetate), with a higher proportion of EVA than the bottom layer 28.

The various layers of the insert may include microperforations to favour the transfer of heat.

In accordance with this embodiment, the insert has a globally triangular shape with rounded corners 24. To encourage the deformation of the outside layer 9 of the innerboot at the level of the interface with the insert, by reducing the forces transmitted to the insert, slots 11 are produced in the outside layer 9 of the innerboot at the level of these corners 24, where these forces are more particularly concentrated.

The functioning of this innerboot 1 and more particularly of its indicators 20 is explained next.

On acquiring a innerboot, a user confirms visually through the raised and/or recessed portions formed on the visible surface of the indicators 20 that the innerboot has not been heated previously, which provides a first indication of the brand new state of the innerboot. Then, in order to proceed to shaping the innerboot to the anatomy of the foot of its future owner, the vendor places the innerboot in an oven to heat it. When the deformation temperature is reached, the deformable material 21 of the indicators 20 tends to revert to its initial shape, because the parts compressed at the level of the compression lines 22 naturally tend to expand to their initial shape, which progressively erases these lines 22, until a substantially plane and uniform surface results, as shown in FIG. 7. The vendor thus confirms visually that the innerboot has reached the correct temperature. The indicators 20 therefore have the function of indicating the correct heating temperature of the innerboot: insufficient heating is immediately detected by the non-deformation of the indicators 20. When this correct heating temperature is reached, the vendor offers the innerboot to its owner, who also notes that the indicators have changed shape. They then put on the innerboot, the thermoformable material 10 of which is at its deformation temperature, and the wall of the innerboot then espouses the volume of their foot. The deformable material of the indicators is naturally chosen so that its deformation temperature is substantially equal to the deformation temperature of the thermoformable padding contained in the intermediate padding layer of the innerboot, or even slightly lower, generally around 80° C., preferably between 60 and 100° C.

The functioning of the indicators is not immaterial; it is based on a change of shape: accordingly, beyond the indication of the correct temperature, these indicators provide visual evidence of the more general but invisible phenomenon of change of shape and/or state of the thermoformable padding material 10 contained in the intermediate layer of the wall of the innerboot 1, which is attractive and reassuring for the owner of the innerboot. Moreover, if the indicator implements a principle of operation similar to that of the intermediate layer of the wall of the innerboot, it indicates more directly the correct reaction of the thermoformable padding material 10 contained in the intermediate layer of the innerboot, which is an even more reliable way to tell that the innerboot is ready to be shaped than the temperature indication alone. As mentioned, its deformable material 21 may be similar or identical to the thermoformable material 10 of the intermediate layer of the innerboot.

Alternatively, any other element that deforms at substantially the same temperature as the wall of the innerboot may be used. Moreover, the deformable material 21 has been shaped by compression and expands when it is heated afterwards. Alternatively, a material could be shaped by expansion and become compressible after heating it, in which case the phenomenon could be demonstrated manually by the vendor and/or the owner of the innerboot touching it. In accordance with another variant, the deformable element could include a shape memory material.

Moreover, the insert described above includes three layers: alternatively, it could include two layers, or any other deformable structure.

In this embodiment, two indicators are used, at the height of the malleolus. This position corresponds to areas of the foot of a user that are particularly sensitive, liable to feel pain if too much pressure is exerted there. Such positioning of the indicators therefore makes it possible on the one hand to measure the temperature of the wall in this particular area for which shaping is important and must be successful and on the other hand to illustrate the comfort function of the innerboot by choosing an appropriate foam density and insisting on its action in these specific areas. Alternatively, an indicator can naturally be disposed anywhere else on the wall of the innerboot, for example in the tongue 6, or at the rear of the innerboot in its upper part. It may be visible on the outside surface of the innerboot, as shown, or on its inside surface, what is important being that the user can easily see it on manipulating their innerboot. Also, an insert as described above may be provided within the inside layer 8 of the innerboot.

Alternatively, the indicators may not only illustrate psychologically the comfort function of the structure of the wall of the innerboot, but contribute directly to comfort in addition to or even instead of the rest of the wall of the innerboot. To this end, the layer of the insert oriented toward the inside of the innerboot may be flexible so that the deformable material therefore acts directly on the comfort of the foot. Alternatively, the rigid layer of the insert, oriented toward the inside of the innerboot, has a non-plane shape adapted to the particular anatomy of the malleolus.

Moreover, two indicators have been implemented, but any other number may be envisaged. One may notably suffice. It is also possible to employ more than two, notably to guarantee the temperature in a number of areas of the innerboot that are far apart.

In accordance with another embodiment, the innerboot may incorporate different indicators to make the indication more reliable. These indicators may be of similar structure but incorporate different deformable materials, for example different thermoformable materials, notably reacting at slightly different temperatures. In particular, an additional indicator could react at the maximum temperature that the foot of the user can withstand, or at the temperature at which the padding material deteriorates. Alternatively, an additional indicator could be associated with the indicator in accordance with the invention, which additional indicator could for example include a component changing colour at a certain temperature, such as a temperature-sensitive ink.

Finally, the solution therefore achieves the stated objects because the deformable element of the indicator guarantees correct shaping of the innerboot.

This embodiment has been described through an indicator taking the form of an insert separate from the innerboot and fixed to the innerboot. Alternatively, the indicator may be formed from the wall of the innerboot itself. To this end, an area of the wall of the innerboot could be preshaped as explained above, the thermoformable padding material 10 of the wall of the innerboot then providing the deformable material function of the indicator. This embodiment would be particularly compatible with the inside surface of the innerboot, because the inside layer 8 is inherently flexible. In this case, this inside layer 8 would preferably be fastened to the padding element 10 over all of its surface.

In both embodiments, it is advantageous to note that the indicator is preferably separate from the rest of the innerboot, particularly from the total or sensibly total part of the wall of the boot, and advantageously from the thermoformable padding material adapted to be shaped after heating of a layer of the wall of the innerboot. Even in the alternative embodiment, the indicator is made by processing a specific short part of the existing wall of the innerboot, so that it becomes separate from the rest of the wall and able to improve the visual effect of the deformation and to become an indicator, on the contrary of the rest of the innerboot.

Moreover, in accordance with another variant embodiment, the indicator takes the form of a removable insert, so that the indicators become interchangeable. Such a variant embodiment has the advantage of enabling the replacement of an indicator on the innerboot, which is particularly useful if the innerboot must be subjected to a new shaping step (by further thermoforming of its wall), for example either if the innerboot is sold on or after a long period of use. To this end, the wall of the innerboot may contain a housing suitable for the reversible positioning of an insert. In another variant, the insert could be fixed to a thermoformable innerboot, for example by means of a hook and loop fastener or a glue, in which case the innerboot could be a standard innerboot with no special housing for the insert. In such a solution, the same insert could be used multiple times, for example by a vendor at a point of sale, the insert undergoing a reshaping step after each use.

Thus one embodiment of the invention also relates to an insert for innerboots for sport shoes as such, characterized in that it includes a deformable element adapted to be deformed at a deformation temperature of a thermoformable padding material of a innerboot wall to indicate that the innerboot has been heated to a temperature substantially equal to its deformation temperature, therefore forming an indicator 20 for innerboots. This insert may include a fixing element, such as a hook and loop fastener or an adhesive tape, suitable for fixing it, preferably removably, to a sport shoe innerboot.

Finally, as stated above, such a innerboot is designed to be assembled with a rigid outside shell to form a ski boot. Alternatively, it may be integrated in a removable or non-removable manner into any sport shoe. This innerboot may also be provided with a more elaborate sole and possibly a more rigid wall, to form an autonomous shoe as such. This type of flexible innerboot with non-skid sole could be particularly useful for board sports on water such as kite surfing, surfing or windsurfing. The term innerboot is therefore to be understood in the wide sense as any footwear item directly receiving the foot of a user and intended to be associated or not with other components to form a finished shoe. The indicator in accordance with the invention is useful for any sport shoe at least a part of which must be thermoformed to the anatomy of the foot, notably for board sports.

The indicator in accordance with the invention is particularly useful for indicating that the innerboot has reached the correct temperature for thermoforming it by the foot of the user, principally in a store, but possibly also for thermoforming it in the factory by inserting a former of predefined shape into the innerboot.

1. Sport shoe innerboot, comprising:
a wall including at least one layer that features an area formed of a thermoformable padding material adapted to be shaped after heating the thermoformable padding material when the thermoformable padding material has been heated to a deformation temperature, and
at least one indicator, including a deformable element deforming at the deformation temperature of the thermoformable padding material of the wall of the innerboot to indicate that the innerboot has been heated to a temperature substantially equal to its deformation temperature, at which shaping the innerboot is possible.

2. Sport shoe innerboot according to claim 1, wherein the indicator includes a thermoformable material.

3. Sport shoe innerboot according to claim 2, wherein the thermoformable material of the indicator includes a shape with raised patterns adapted to be attenuated or to disappear after the indicator is heated to the deformation temperature of the wall.

4. Sport shoe innerboot according to claim 3, wherein the raised patterns of the deformable material of the indicator are formed by compression lines.

5. Sport shoe innerboot according to claim 1, wherein the at least one indicator is disposed laterally in a vicinity of the malleolus.

6. Sport shoe innerboot according to claim 1, wherein the indicator in the form of an insert integrated into an inside layer or an outside layer of the wall of the innerboot in a vicinity of an opening in said layer to render the indicator visible from inside or outside the innerboot, respectively.

7. Sport shoe innerboot according to claim 6, wherein the insert includes a first layer, a second layer visible from outside the innerboot, wherein the second layer is at least one of (i) flexible and (ii) elastic, and a deformable material disposed between the two layers.

8. Sport shoe innerboot according to claim 7, wherein the insert includes a peripheral area fixed to the second, outside layer of the innerboot by any of (i) stitching extending over all its periphery, (ii) gluing and (iii) welding.

9. Sport shoe innerboot according to claim 6, wherein the insert is removable.

10. Sport shoe innerboot according to claim 1, wherein the least one indicator is positioned in a layer of a wall of the a tongue of the innerboot.

11. Sport shoe innerboot according to claim 1, wherein an inside layer of the deformable element of the indicator is also deformed by insertion of a foot into the innerboot after the indicator is heated to participate in shaping the innerboot around the foot and to contribute to the comfort of the innerboot.

12. Innerboot according to claim 1, comprising a sole to form an autonomous sport shoe.

13. Sport shoe including an outside shell and a comfort innerboot according to claim 1.

14. Sport shoe according to claim 13, wherein the comfort innerboot is removable.

15. Method of manufacturing a sport shoe innerboot according to claim 1, wherein the method comprises:
shaping an insert including a deformable material with raised patterns in a mould; and
fixing the insert in an opening of a wall of a sport shoe innerboot so as to leave the raised patterns of the insert visible.

16. Sport shoe innerboot according to claim 1, wherein the deformable material of the indicator is separate from the thermoformable padding material of the wall of the innerboot.

17. Sport shoe innerboot according to claim 4, wherein the compression lines are of grid type.

18. Sport shoe innerboot according to claim 1, wherein the indicator in the form of an insert integrated into an inside layer or an outside layer of the wall of the innerboot in a vicinity of an opening in said layer to render the indicator visible from any of (i) inside and (ii) outside the innerboot.

19. Sport shoe innerboot according to claim 1, wherein the indicator in the form of an insert integrated into an inside layer or an outside layer of the wall of the innerboot in a vicinity of an opening in said layer to render the indicator visible from inside the innerboot.

20. Sport shoe innerboot according to claim 1, wherein the indicator in the form of an insert integrated into an inside layer or an outside layer of the wall of the innerboot in a vicinity of an opening in said layer to render the indicator visible from outside the innerboot.
